(19) United States
(12) Patent Application Publication
(10) Pub. No.: US 2011/0023265 A1
(43) Pub. Date: Feb. 3, 2011

(54) ADAPTER BUSHING FOR A SENSOR

(76) Inventor: Günther Singbartl, Hannover (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/734,649

(22) PCT Filed: Oct. 14, 2008
(86) PCT No.: PCT/EP2008/008676

§ 371 Date: Aug. 27, 2010

(30) Foreign Application Priority Data
Nov. 22, 2007 (DE) 10 2007 056 340.1

(51) Int. Cl. G01D 11/30

(52) U.S. Cl. 16/2.1

(57) ABSTRACT

The invention relates to an adapter bushing (6) for a sensor (1) for fixing and adjusting the sensor (1) in a non-positive manner in a bore of a retaining piece, wherein the adapter bushing (6) is provided with at least one resilient tongue (2) and at least one fixed point (10), wherein the at least one resilient tongue (2) is connected on one side to the adapter bushing (6) and is freely movable on the tip thereof, wherein at least one lift/guide element (15, 15′) is disposed before at least one fixed point (10) and/or at least one resilient tongue (2).

The present invention generally relates to an adapter bushing for a sensor according to the preamble of claim 1.

Sensors, in particular rod-type sensors serve, for example, to sense the speed of a wheel of a truck. This speed information is used, for example, as an input variable of an ABS—anti-lock braking system. Opposite the rod-type sensor, which is connected to the vehicle's bodywork, is a toothed pole wheel connected to the wheel. The correct air gap between the rod-type sensor and pole wheel is important for the function of the arrangement and should be maintained at low tolerances. It should also be taken into consideration that the rod-type sensor and its production and installation should take place on a large-series basis and therefore the manufacturing complexity should not be too great.

In the case of axles with disc brakes, which at present are increasingly being used on trucks, comparatively more radiation heat occurs in the sensor installation space during and after braking from the disc brake to the sensor or the installation location thereof. In these vehicles, this generally gives rise to significantly higher ambient temperatures in the installation area of the sensor, to be more precise of the sensor head area. This increased heat occurs for a relatively long time or else only briefly.

The thermal application range for ABS sensors for application in utility vehicles is differentiated according to continuous temperature from −40° C. to +150° C. and a short-term temperature of +180° C., with the short term being an hour. Under marginal conditions it is possible for the brake discs in trucks also to reach temperatures of +500° C. and even up to +700° C.

The document “WABCO Anti-Blockier-System [WABCO Anti-Lock Brake System]”, issued September '81, discloses mounting the rod-type sensor by means of an adapter bushing in a bore of a rod-type sensor holder with a defined non-positive engagement. Such merely non-positive mounting or adjustment is necessary so that the rod-type sensor can move back when contact occurs with the pole wheel lying opposite, thereby avoiding damage. Furthermore, the simple mounting by plugging in the rod-type sensor is advantageous. The securing force, which is generated by the non-positive engagement, has to be so large that the rod-type sensor cannot move independently even when its holder oscillates, for example, by screeching brakes.

On the other hand, the securing force must not be too large so that the abovementioned plugging in of the rod-type sensor and the moving back before the pole wheel is still possible without auxiliary tools and also so that the frictional forces do not become too large during self-adjustment of the sensor (automatic setting of the air gap) during operation. During this automatic setting of the air gap in the travel mode and as a result of temporary contact of the pole wheel with the sensor, which occurs in the process, for example, in the event of wheel bearing play and elastic deformations in the axle, additional heat is also input into the sensor due to frictional heat.

The component that is decisive for the generation of the securing force is an adapter bushing that is, for example, punched out from beryllium bronze. In addition, the surface qualities of the rod-type sensor and of the bore of the rod-type sensor holder also play a role.

The adapter bushing is embodied such that non-positive engagement both secures the adapter bushing itself in the bore of the rod-type sensor holder and also secures the rod-type sensor, which has been plugged into the adapter bushing. For this purpose, the adapter bushing is, as illustrated in the abovementioned document, provided with resilient tongues. The tips of these tongues make contact with the inner wall of the bore of the rod-type sensor holder. The middle parts, bent inward, of the tongues are in contact with the rod-type sensor and press it onto fixed points, lying opposite and generated by pressing in of the adapter bushing casing, of the adapter casing.

In addition, DE 32 29 207 C2 describes an adapter bushing for a rod-type sensor in which the middle part of each tongue is widened and at the same time the part of the tongues that is bent inward lies between their broadest point and the tip of the tongue. In this context, the one-sided arrangement of the tongues with fixed points lying opposite inevitably brings about an eccentric plugged position of the rod-type sensor in the end secured position, which leads to lateral displacement during the plugging of the rod-type sensor, and as a result no radial force effect, necessary for the best possible configuration and effect, is applied to the tongues. This results in varying force values and a non-uniform force profile.

The securing forces which vary as far as relative large values bring about frictional forces that are temporarily increased during use and an additional heat effect on the sensor. The frictional heat that arises from the clamping forces is added to the high ambient temperatures, which are often already present in any case in the sensor area and in this respect are particularly significant in utility vehicles with disc brakes. This additional application of heat is directly dependent on the adapter bushing clamping force that is actually present and that should therefore deviate as little as possible from the setpoint value, which is necessary for the securing function.

The present invention is based on the object of improving an adapter bushing of the general type mentioned above such that the accuracy and uniformity of the defined securing forces of the sensor in the receptacle bore and adapter bushing are improved in a simple and cost-effective way.

This object is achieved by the characterizing features of claim 1. The subclaims contain advantageous developments of the invention.

An advantage is that overall lower thermal loading of the sensor during use and indirectly also a reduction in the mechanical loading are brought about.

Furthermore, it is advantageous that due to the adapter bushing according to embodiments of the invention it is possible to maintain the required clamping force with very little tolerance in a relatively precise way even when manufacturing the adapter bushing. As a result, subsequent testing costs for the adapter bushing can be reduced since (as a result of the uniform force profile that is achieved) electronic evaluation of the measured value of the force is made possible. The quality and processability in the production chain as far as the customer and overall lower thermal loading of the sensor during use and indirectly also of the mechanical loading are achieved as a result.

The adapter bushing according to embodiments of the invention is particularly suitable for what are referred to as rod-type sensors, i.e. for sensors with a substantially cylindrical shape.

According to embodiments of the invention, the adapter bushing has what are referred to as fixed points, wherein a sensor inserted into the adapter bushing is pressed, on the one hand, by at least one resilient tongue against at least one fixed point. In the process, the fixed point lies essentially opposite the resilient tongue. It should be understood that the term “fixed point” does not mean only a punctuate contact area but also a linear or even a planar contact area between the sensor and the adapter bushing.

Furthermore, the adapter bushing has, according to embodiments of the invention, at least one so-called lift/guide element that is arranged before at least one fixed point and/or at least one resilient tongue. Here, the “before” is to be considered to be from the direction of the sensor that is to be plugged in. That is, during the plugging-in process the sensor is first in contact with the lift/guide element and only in contact with a fixed point or a resilient tongue during the further plugging-in process. In this context, during the plug-in process the sensor is lifted in the direction of the fixed point or the resilient tongue by the lift/guide element. The lift/guide elements therefore have a lower height than the fixed points when viewed in the radial direction of the adapter bushing.

In a further advantageous embodiment, the adapter bushing has, on the edge directed toward the plugging-in side, a chamfer (“insertion chamfer”) that facilitates the plugging of the adapter bushing into the associated bore. This chamfer preferably has an angle in the range from 10°-20° with respect to the axial direction of the adapter bushing. An angle of 15° is particularly preferred for the chamfer.

Furthermore, according to one embodiment there is provision to provide an insertion contour at at least one location on the edge, directed in the direction of the plugging-in side, of the adapter bushing. This insertion contour is essentially oriented at an angle to the axial direction of the adapter bushing and can have a linear contour or a round contour. This contour is advantageously arranged on the longitudinal slot that is provided by the manufacturer. This insertion contour facilitates the plugging in of the adapter bushing into the associated bore to the extent that the adapter bushing can also be inserted into the bore at a slight incline to the plugging-in direction. This facilitates the mounting of the adapter bushing, in particular in the case of bores that are unfavourably located or difficult to access. The insertion contour preferably has an angle in the range 25°-30° with respect to the longitudinal slot. An angle of 28° is particularly preferred for the insertion contour.

The adapter bushing is advantageously essentially composed of a spring material such as, for example, beryllium bronze (CuBe) or chrome nickel (CrNi).

The longitudinal slot is advantageously linear, i.e. oriented in a purely axial direction of the adapter bushing. This linear design means that the longitudinal slot does not have any extent in the radial direction of the adapter bushing, which facilitates the plugging of the adapter bushing into a bore in the rod-type sensor holder, since the adapter bushing cannot tilt in the bore.

Exemplary embodiments of the invention are illustrated in the accompanying drawings and will be described in more detail in the text which follows.

In the drawings:

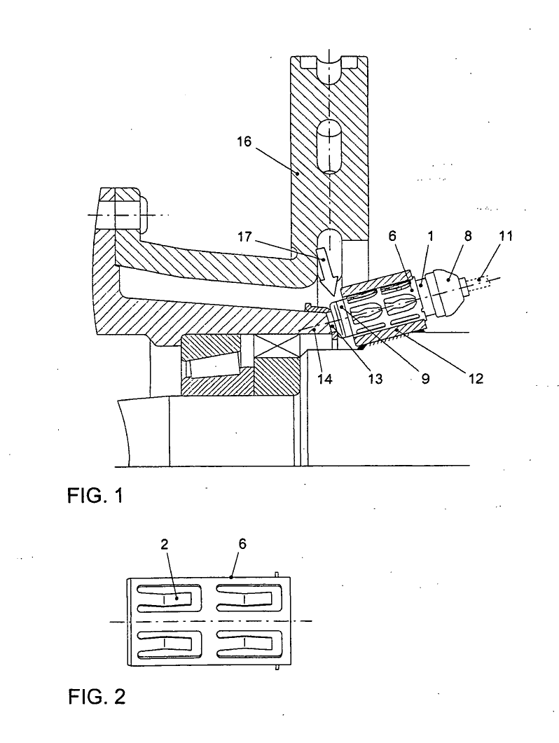

FIG. 1 shows a rod-type sensor that is secured in a bore by means of an adapter bushing,

FIG. 2 shows an adapter bushing according to the prior art,

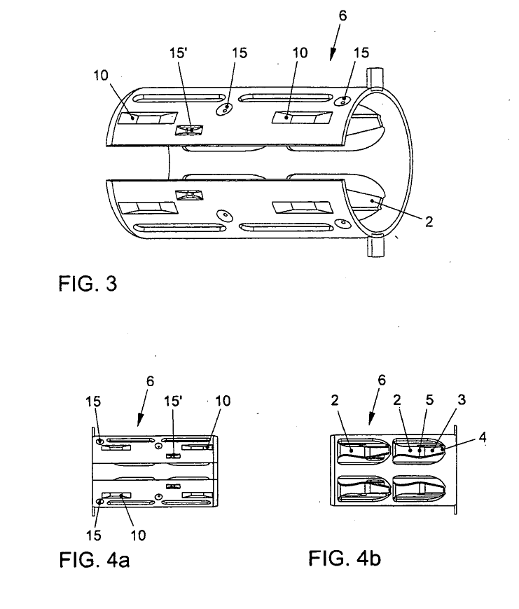

FIG. 3 shows a first exemplary embodiment of an adapter bushing,

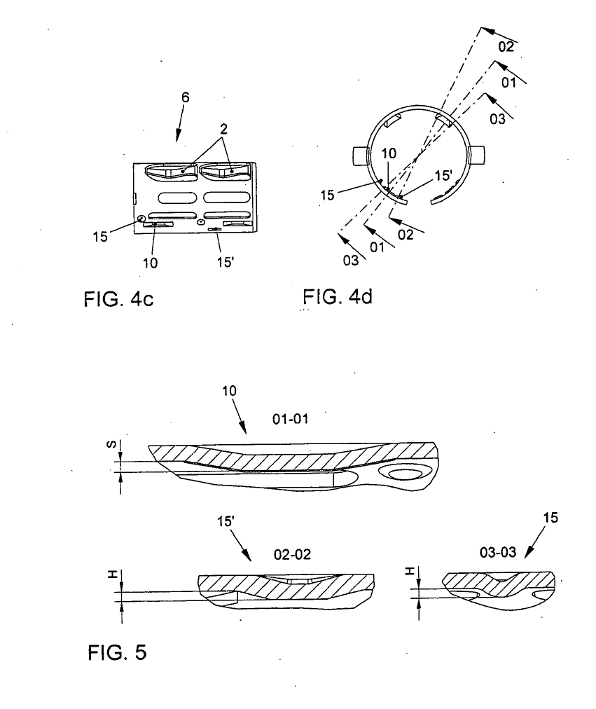

FIG. 4 shows the first exemplary embodiment according to FIG. 3 in four views,

FIG. 5 shows a detail of the fixed points and lift/guide elements according to FIG. 4,

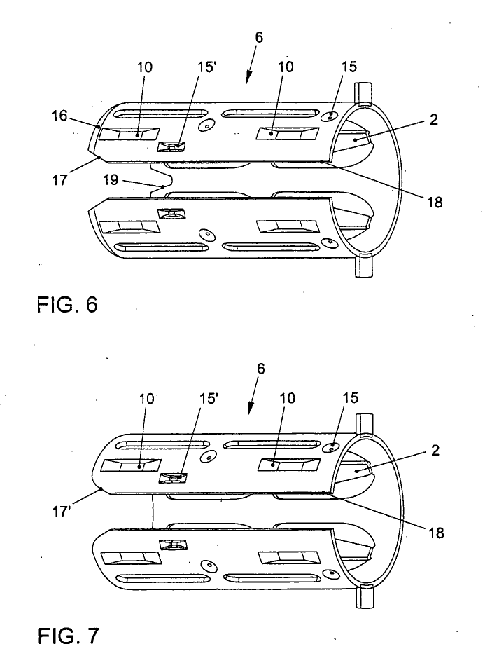

FIG. 6 shows a second exemplary embodiment of an adapter bushing with an insertion chamfer and insertion contour, and

FIG. 7 shows a third exemplary embodiment of an adapter bushing with an insertion contour.

FIG. 1 illustrates a rod-type sensor 1 that serves to measure the rotation of a vehicle wheel. The rod-type sensor 1 is mounted in a bore of a securing part 12 that is fixed with respect to the vehicle bodywork. The adapter bushing 6 is located between the rod-type sensor 1 and the securing part 12. A toothed pole wheel is located opposite the head 9 of the rod-type sensor 1. The pole wheel 13 is fixedly connected to the wheel hub 14 of a vehicle wheel. The foot 8 of the rod-type sensor 1 is provided with an electric connecting cable 11. The brake disc 16 is located adjacent to the sensor, and the radiation heat generated during braking is illustrated by means of an arrow 17.

In order to mount the rod-type sensor 1, it is first pushed into the bore of the securing part 12 counter to the friction force of the adapter bushing 6 until the rod-type sensor 1 is in contact with the pole wheel 13. During operation of the vehicle, the rod-type sensor 1 is then again pushed back a certain amount by the pole wheel 13, with the result that a final air gap is set. During this automatic setting of the air gap in the travel mode and as a result of temporary contact of the pole wheel 13 with the sensor 1, which occurs in the process, i.e. in the event of wheel bearing play and elastic deformations in the axle, additional heat is input to the sensor 1 as a result of the generated friction heat. The securing forces of the adapter bushing 6 which vary as far as relatively large values bring about friction forces that are temporarily increased during use, and an additional application of heat onto the sensor 1. The friction heat that is produced by the clamping forces is often also added to the ambient temperatures, which are in any case already high in the sensor area, and in this respect is particularly significant in utility vehicles with disc brakes. This additional application of heat is directly dependent on the present clamping force of the adapter bushing 6, which should therefore deviate as little as possible from the setpoint value necessary for the securing function. The securing force that is generated by the adapter bushing 6 has to be strong enough during the rest of the operation to secure the rod-type sensor 1 in this position.

FIG. 2 illustrates an adapter bushing 6 according to the prior art. The adapter bushing 6 is in the form of a slotted sleeve and is latched in diameter to the diameter of the rod-type sensor. The clamping effect is generated by four relatively short tongues 2 of constant width, which tongues 2 press the rod-type sensor onto fixed points 10 (not shown in FIG. 2) lying opposite. The dot-dash line represents the central axis of the adapter bushing 6.

The pressing of the rod-type sensor 1 against fixed points has the advantage that oscillation of the rod-type sensor 1 is largely prevented. This could occur with the rod-type sensor 1, which was merely mounted in resilient tongues 2, and could lead to incorrect electrical signals.

FIG. 3 shows a first embodiment of the adapter bushing 6 according to the invention in a perspective illustration. The adapter bushing 6 here has resilient tongues 2, fixed points 10 for securing a rod-type sensor 1 in an end secured position and lift/guide elements 15 and 15′. In this embodiment, the adapter bushing 6 has in each case four resilient tongues 2 (only partially visible here) that are arranged on one side of the axis, and fixed points 10 that lie approximately opposite the resilient tongues 2 and by means of which a rod-type sensor 1 is secured in the mounted position of a precisely defined frictional and non-positive engagement. The fixed points 10 and the lift/guide elements 15 and 15′ are embodied here as additional formations in/on the casing surface of the adapter bushing 6. The fixed points 10 and the lift/guide elements 15 and 15′ can be manufactured, for example, by a stamping and punching process. The lift/guide elements 15 and 15′ are arranged spatially in front of the front and rear fixed points 10, with the lift/guide elements 15 and 15′ having a shorter extent in the radial direction than the fixed points 10. As a result, the rod-type sensor is lifted in the direction of the fixed points 10 by the lift/guide elements 15 and 15′ during the plugging in to the adapter bushing 6, as a result of which virtually tilt-free plugging in of the rod-type sensor 1 is ensured. As a result of this stepped lifting of the rod-type sensor 1 to the level of the fixed points 10, less force is necessary to insert the rod-type sensor 1 into the adapter bushing 6. Furthermore, the accuracy and uniformity of the forces or plugging force characteristic curve are increased and/or ensured by the additional lift/guide elements 15 and 15′. The lift/guide elements 15 and 15′ can also be arranged spatially only before the front or before the rear fixed points 10.

The lift/guide elements 15 and 15′ in an adapter bushing 6 can be embodied such that they are either all “round” (see reference symbol 15) or “ramp-like” (see reference symbol 15′) or else “mixed”, i.e. both “round” and “ramp-like”.

FIG. 4 shows the first exemplary embodiment according to FIG. 3 in four views and with two types of lift/guide elements 15 and 15′. FIG. 4a shows a first side view of the adapter bushing 6 with essentially the fixed points 10 and the lift/guide elements 15 and 15′ being visible. FIG. 4b shows a second side view of the adapter bushing 6, with this side of the adapter bushing 6 lying opposite the first side according to FIG. 4a. The second side view of the adapter bushing 6 shows essentially the resilient tongues 2.

The resilient tongues 2 can be embodied here such that they are straight (see FIG. 2) or prolonged and of various width (see FIG. 4b). The resilient tongues 2 are folded here approximately in their center, with the result that the part of the resilient tongue that starts at the adapter bushing casing is first bent inward and then bent outward starting approximately from the center (see FIG. 2). In contrast, the resilient tongues 2 according to FIG. 4b are first bent inward to beyond their widest location 5 and then bent outward as far as the tip 4 of the tongue. The outward-bent part of the resilient tongues 2 is provided here with the reference symbol 3. This outward-bent part of the resilient tongues 2 lies here between the widest location 5, which is located approximately in the center of the resilient tongue 2, and the tip 4 of the tongue.

A relatively small distance is brought about between the respective tip 4 of the tongue and the adapter bushing casing lying opposite since in two separate working operations during the manufacture of the adapter bushing 6 the tongues 2 are first stamped and subsequently the tips 4 of the tongues are separated.

FIG. 4c shows a further side view of the adapter bushing 6, with both the resilient tongues 2 and the fixed points 10 as well as the lift/guide elements 15 and 15′ being illustrated.

FIG. 4d shows a plan view of the adapter bushing 6 with sectional lines through the fixed points 10 (section 01-01), the lift/guide elements 15 (section 03-03) and the lift/guide elements 15′ (section 02-02).

The lift/guide elements can be embodied such that they are rounded or hemispherical (reference symbol 15) or ramp-shaped or elongate (reference symbol 15′). It is also possible to arrange a plurality of lift/guide elements 15 and 15′ before a fixed point 10, wherein, for example when two lift/guide elements 15 and 15′ are used, the latter have a different extent in the radial direction, with the result that when the rod-type sensor 1 is plugged in it is first lifted slightly by the first lift/guide element 15 or 15′ in order then to be lifted somewhat further in the direction of the fixed point 10 by the second lift/guide element 15 or 15′. This implements stepped lifting of the rod-type sensor 1 in the direction of the fixed points 10. Various embodiments of the lift/guide elements 15 and 15′ are conceivable for the stepped lifting of the rod-type sensor 1 in the direction of the fixed points 10, for example, FIG. 4a illustrates lift/guide elements 15′ with a ramp-shaped contour, which also permits the rod-type sensor 1 to be moved toward the fixed points 10 in a stepped fashion.

The lift/guide elements 15 and 15′ can be arranged directly or else offset in the longitudinal direction before a fixed point 10 here. If a plurality of lift/guide elements 15 and 15′ are used, they can be arranged either directly one behind the other in the longitudinal direction or offset with respect to one another and with respect to the fixed point 10.

FIG. 5 shows in enlarged form the three sections according to FIG. 4d. The section through the fixed point 10 is denoted by 01-01, the section through the ramp-like lift/guide element 15′ by 02-02 and the section through the rounded lift/guide element 15 by 03-03. The level of the fixed point 10 is denoted by “S”, and the level of the lift/guide element 15 or 15′ is denoted by “H”. The level H of the lift/guide element 15 or 15′ is lower than the level S of the fixed point 10. The lift/guide elements 15 and 15′ are therefore lower than the fixed points 10.

In the mounted state of the adapter bushing 6 and of the rod-type sensor 1, the tongues 2 can point both to the foot 8 (see FIG. 1) of the rod-type sensor and to the head 9 of the rod-type sensor 1.

According to one embodiment of the invention (not illustrated) it is also possible for some of the tongues 2 to point to the foot 8 and for some others of the tongues 2 to point to the head 9 of the rod-type sensor 1. In this context, that part (referred to as the foot point) of the resilient tongues 2 that is connected to the adapter bushing 6 can be mounted in the central part of the adapter bushing 6, and the resilient tongues 2 each point outward. In this embodiment, the outward bent parts 3 of the tongues 2 with the rod-type sensor 1 lie particularly far from one another.

In addition it is also possible for the adapter bushing 6 to have in each case two or more fixed points per resilient tongue 2. In this context, for example, the resilient tongues 2 and the two fixed points 10 can be distributed uniformly over the circumference of the adapter bushing 6.

FIG. 6 shows a second exemplary embodiment of an adapter bushing 6 with an insertion chamfer 16 and a first insertion contour 17. The adapter bushing 6 has an insertion chamfer 16 on the edge directed toward the plugging-in side, i.e. the side of the adapter bushing that is first plugged into the bore in a securing part 12 (see FIG. 1), which insertion chamfer 16 facilitates the plugging of the, adapter bushing into the associated bore. The insertion chamfer 16 extends here over the entire circumference of the edge that is directed towards the plugging-in side. Furthermore, the adapter bushing 6 can have a first insertion contour 17 instead of or in addition to the insertion chamfer. This first insertion contour 17 is embodied here so as to be linear at an angle to the longitudinal slot 18. The longitudinal slot 18 of the adapter bushing has here a linear contour, i.e. the longitudinal slot extends solely in the axial direction of the adapter bushing 6. Furthermore, the adapter bushing 6 has, according to FIG. 6, a further insertion contour 19 that can be arranged in addition to the first insertion contour 17 on the same edge of the adapter bushing 6. The further insertion contour 19 can also be used without the first insertion contour 17. The first and/or further insertion contours 17 and 19, respectively, can be arranged at any desired location on the edge of the plugging-in side of the adapter bushing 6. It is also possible to use a plurality of insertion contours (not shown here). The further reference symbols in FIG. 6 are identical to those in FIGS. 1 to 5.

FIG. 7 shows a third exemplary embodiment of an adapter bushing 6 with a second insertion contour 17′ that has a rounded contour. This second insertion contour 17′ can either be arranged on the linear longitudinal slot 18 of the adapter bushing 6 or at one or more other locations on the adapter bushing 6 (not shown). The further reference symbols in FIG. 7 are identical to those in FIGS. 1 to 6. In the second exemplary embodiment according to FIG. 7 it is also possible to use an insertion chamfer (see reference symbol 16 in FIG. 6). In addition, a combination of differently shaped (linear; rounded) insertion contours (see reference symbols 17, 17′, 19 in FIGS. 6 and 7) on an adapter bushing 6 in conjunction with an insertion chamfer 16 or without an insertion chamfer 16 is also covered by the inventive concept.

1. An adapter bushing (6) for a sensor (1) for fixing and adjusting the sensor (1) in a non-positive manner in a bore of a securing part (12), wherein the adapter bushing (6) is provided with at least one resilient tongue (2) and at least one fixed point (10), wherein the at least one resilient tongue (2) is connected on one side to the adapter bushing (6) and is freely movable on the tip thereof, characterized in that at least one lift/guide element (15; 15′) is arranged before at least one fixed point (10) and/or at least one resilient tongue (2).

2. The adapter bushing according to claim 1, characterized in that the at least one lift/guide element (15) has an essentially hemispherical contour.

3. The adapter bushing according to claim 1, characterized in that the at least one lift/guide element (15′) has a ramp-shaped contour.

4. The adapter bushing according to one or more of claims 1 to 3, characterized in that the at least one resilient tongue (2) is arranged essentially with its axis parallel to the longitudinal axis of the adapter bushing (6).

5. The adapter bushing according to one or more of claims 1 to 4, characterized in that the middle part of the at least one resilient tongue (2) is widened.

6. The adapter bushing according to claim 5, characterized in that the at least one resilient tongue (2) is firstly bent inward to beyond its widest point (5), and is then bent outward as far as its tongue tip (4).

7. The adapter bushing according to one or more of claims 1 to 6, characterized in that the sensor (1) is pressed by the at least one resilient tongue (2) against fixed points (10), generated by pressing in the adapter bushing casing, of the adapter bushing (6).

8. The adapter bushing according to one or more of claims 1 to 7, characterized in that the at least one lift/guide element (15; 15′) has a smaller height in the radial direction of the adapter bushing (6) than the at least one fixed point (10).

9. The adapter bushing according to one or more of claims 1 to 8, characterized in that in the mounted state the sensor (1) is supported on the at least one resilient tongue (2).

10. The adapter bushing according to one or more of claims 1 to 9, characterized in that a plurality of lift/guide, elements (15; 15′) are arranged before at least one fixed point (10), wherein the plurality of lift/guide elements (15; 15′) each have different heights in the radial direction of the adapter bushing (6).

11. The adapter bushing according to one or more of claims 1 to 10, characterized in that in the mounted state of the adapter bushing (6) the at least one resilient tongue (2) points to the foot (8) or to the head (9) of the sensor (1).

12. The adapter bushing according to one or more of claims 1 to 11, characterized in that the adapter bushing has a plurality of resilient tongues (2), wherein some of the resilient tongues (2) point to the foot (8), and some others of the resilient tongues (2) point to the head (9) of the sensor (1).

13. The adapter bushing according to claim 12, characterized in that the foot points of the resilient tongues (2) are attached in the central part of the adapter bushing (6), and the resilient tongues (2) point to the respective edge of the adapter bushing (6).

14. The adapter bushing according to one or more of claims 1 to 13, characterized in that the adapter bushing (6) has an insertion chamfer (16) on the edge directed toward the plugging-in side, i.e. the side of the adapter bushing which is first plugged into the bore in a securing part (12).

15. The adapter bushing according to one or more of claims 1 to 14, characterized in that the adapter bushing (6) has at least one insertion contour (17; 17′; 19).

16. The adapter bushing according to claim 15, characterized in that the insertion contour (17, 17′, 19) has a linear or a rounded contour.
